(19) United States
(12) Patent Application Publication
(10) Pub. No.: US 2026/0156734 A1
(43) Pub. Date: Jun. 4, 2026

(54) METHOD AND SYSTEM FOR FIELD LIGHTING SYSTEM COMMISSIONING

(71) Applicant: ABL IP Holding LLC, Atlanta, GA (US)

(72) Inventors: Christopher D. Nolan, Camillus, NY (US); Joseph R. Casper, Baldwinsville, NY (US)

(21) Appl. No.: 19/409,246

(22) Filed: Dec. 4, 2025

Related U.S. Application Data
(60) Provisional application No. 63/728,103, filed on Dec. 4, 2024.

(51) Int. Cl. H05B 47/175; G01S 17/894; G06T 7/70; H05B 47/11; H05B 47/125

(52) U.S. Cl. CPC H05B 47/199; G01S 17/894; G06T 7/70; H05B 47/11; H05B 47/125; H05B 47/196; H05B 47/1985; G06T 2207/10028; G06T 2207/20221

(57) ABSTRACT

A method of commissioning a lighting system includes: receiving a photometric plan for a group of light fixtures; receiving a digital image of a first luminaire of a first light fixture of the group, wherein the digital image is received from a camera that is connected to a second light fixture of the group; receiving LiDAR data that represents a LiDAR image of the first luminaire, wherein the LiDAR data is received from a LiDAR sensor that is connected to the second or another light fixture of the group; processing the digital image and LiDAR data to determine a position and an orientation of the luminaire; comparing the determined position and orientation to the position metrics to assess whether the luminaire is positioned and oriented in accordance with the photometric plan; and indicating whether the luminaire is positioned and oriented in accordance with the photometric plan.

### RELATED APPLICATIONS AND CLAIM OF PRIORITY

This patent document claims priority to U.S. Provisional Patent Application No. 63/728,103 , filed Dec. 4, 2024. The disclosure of the priority application is fully incorporated into this document by reference.

### BACKGROUND

Fields, parks, stadiums, and other facilities that host sporting events and other activities typically operate many light fixtures to properly illuminate playing surfaces, event stages, and other locations where the events happen. For many such events, it is a goal of the lighting system to maintain substantially consistent lighting conditions over the entire illuminated surface. For example, in the context of sports events, if an area of the event's field is either too dark or too bright, it can impair the ability of players and referees to properly see the ball, other players, and events happening on the field. This means that light fixtures must be properly installed and maintained to ensure light is properly distributed over the target area.

Commissioning of lights to meet a specified photometric plan is not a simple task. Although in an ideal situation all light poles would be perpendicular to the ground and parallel to each other, variations in the contour of the field, and even variations in the light pole structures themselves, can cause slight misalignments. In addition, during installation technicians will aim each luminaire in a precise direction, but the installation process can jostle the luminaire and cause it to become misaligned. Upon installation, luminaires may exhibit minor deviations from the photometric plan that are too small to be perceived by human eyes, but which can cause significant changes in the resulting illumination on one or more locations of the field. In addition, over time, facility vibrations and (in the case of outdoor facilities) wind can cause light fixtures to move and become misaligned with a target area on the field. These issues can cause the distribution of light over a field to become uneven, leading to dark spots and/or too bright areas on the field.

This document describes methods and systems that address at least some of the problems described above.

### SUMMARY

This document discloses systems and methods for commissioning light fixtures. A method embodiment includes, by a processor, receiving a photometric plan for a group of light fixtures. The photometric plan includes position metrics for each of the light fixtures at a facility, and the position metrics for each light fixture include a location of the light fixture and an orientation of a luminaire of the light fixture. The method also includes: (i) receiving a digital image of a first luminaire of a first light fixture of the group, wherein the digital image is received from a camera that is connected to a second light fixture of the group; (ii) receiving LiDAR data that represents a LiDAR image of the first luminaire, wherein the LiDAR data is received from a LiDAR sensor that is connected to the second light fixture or another light fixture of the group; (iii) processing the digital image and the LiDAR data to determine an orientation of the first luminaire; (iv) comparing the determined orientation to the position metrics to assess whether the first luminaire is oriented in accordance with the photometric plan; and (v) outputting a report indicating whether the first luminaire is oriented in accordance with the photometric plan.

In various system embodiments, a light commissioning system includes: (i) a processor; (ii) a memory storing a photometric plan for a group of light fixtures, wherein (a) the photometric plan includes position metrics for each of the light fixtures at a facility, and (b) the position metrics for each light fixture include a location of the light fixture and an orientation of a luminaire of the light fixture; and (iii) a memory containing programming instructions. The programming instructions will, when executed, cause the processor to: (a) receive a digital image of a first luminaire of a first light fixture of the group, wherein the digital image is received from a camera that is connected to a second light fixture of the group; (b) receive LiDAR data that represents a LiDAR image of the first luminaire, wherein the LiDAR data is received from a LiDAR sensor that is connected to the second light fixture or another light fixture of the group; (c) process the digital image and the LiDAR data to determine an orientation of the first luminaire; (d) compare the determined orientation to the position metrics to assess whether the first luminaire is oriented in accordance with the photometric plan; and (e) output a report indicating whether the first luminaire is oriented in accordance with the photometric plan.

In additional system embodiments, a lighting system includes a light system comprising a group of light fixtures positioned to direct light toward a target area of a facility, wherein each light fixture includes a stand and one or more luminaires. The system of these embodiments also comprises a plurality of cameras, each of which is connected to one of the light fixtures, and a plurality of LiDAR sensors, each of which is connected to one of the light fixtures. The system of these embodiments also includes a processor, and a memory storing a photometric plan for the group of light fixtures, wherein the photometric plan includes position metrics for each of the light fixtures, and wherein the position metrics for each light fixture include a location of the light fixture and an orientation of the one or more luminaires of the light fixture. The system of these embodiments also includes a memory containing programming instructions that upon execution will, when executed, cause the processor to: (i) receive a digital image of a first luminaire of a first light fixture of the group, wherein the digital image is received from a camera that is connected to a second light fixture of the group; (ii) receive LiDAR data that represents a LiDAR image of the first luminaire, wherein the LiDAR data is received from a LiDAR sensor that is connected to the second light fixture or another light fixture of the group; (iii) process the digital image and the LiDAR data to determine an orientation of the first luminaire; (iv) compare the determined orientation to the position metrics to assess whether the first luminaire is oriented in accordance with the photometric plan; and (v) output a report indicating whether the first luminaire is oriented in accordance with the photometric plan.

Other embodiments are directed to a computer program product comprising a non-transitory memory device storing programming instructions that will, upon execution, cause a processor to implement any of the method embodiments listed above.

### BRIEF DESCRIPTION OF THE DRAWINGS

FIG. 1 illustrates example elements of a field lighting system.

FIG. 2 illustrates example elements of a photometric plan for a target area such as the playing surface of a football field.

FIG. 3 illustrates example illumination metrics of a photometric plan for a target area.

FIGS. 4A-4C illustrate additional photometric parameters of a photometric plan. FIG. 4A illustrates horizontal orientation of luminaires with respect to a boundary of a target area. FIG. 4B illustrates vertical orientation of a luminaire with respect to the ground level of a target area. FIG. 4C illustrates height and orientation metrics for various luminaires of a particular light fixture.

FIG. 5 illustrates an example light fixture with a camera and LiDAR sensor installed on it.

FIG. 6 illustrates an example method of commissioning a set of light fixtures.

FIG. 7 illustrates example components of an electronic device that may be used in an outdoor lighting activation system.

### DETAILED DESCRIPTION

In this document, the singular forms “a,” “an,” and “the” include plural references unless the context clearly dictates otherwise. Unless defined otherwise, all technical and scientific terms used in this document have the same meanings as commonly understood by one of ordinary skill in the art. As used in this document, the term “comprising” (or “comprises”) means “including (or includes), but not limited to.”

As used in this document, the term “commissioning” refers to the process of verifying whether a system has been installed and/or maintained to meet a set of specifications. Commissioning can occur at the time of installation, as well as at any time after installation as part of an operational and/or maintenance review.

Additional terms that are relevant to this disclosure will be defined at the end of this Detailed Description section.

This disclosure relates to methods and systems for commissioning lighting systems such as sports field lights and/or park lighting. Embodiments described in this disclosure accomplish this by integrating cameras and light detection and ranging (LiDAR) systems within a smart lighting solution. The commissioning system enables monitoring, dynamic field management, security, and remote system commissioning. Powered by a shared auxiliary low-voltage supply with battery backup, the system can leverage advanced artificial intelligence (“AI”) analytics, motion-triggered recording, and three-dimensional (“3D”) spatial mapping through LiDAR. In embodiments, cameras and LiDAR sensors are integrated into the lighting infrastructure, providing real-time diagnostics, security alerts, and/or efficient remote commissioning to simplify operations and enhance field performance.

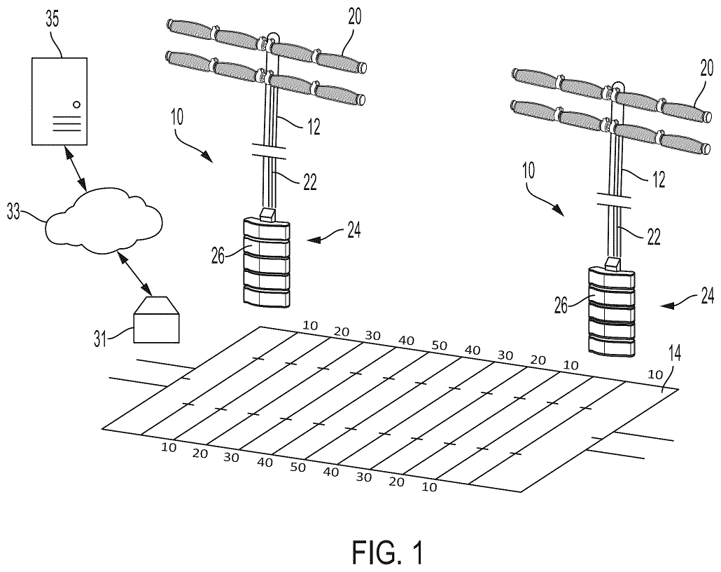

FIG. 1 illustrates example elements of a field lighting system. The system includes multiple light fixtures 10, each of which is positioned to illuminate a target area 14, such as a sports field, pitch, park, amphitheater, or parking lot. Each light fixture 10, when installed at a facility that includes a target area 14, will illuminate the target area 14 when activated. This document may use the term “field” generally to refer to any such outdoor target area that is illuminated by one or more light fixtures. Each system will include multiple light fixtures. For example, a baseball field may be illuminated by four light fixtures, while a football field may be illuminated by six light fixtures. Additional features about example light fixtures 10 will be described below and are also described in U.S. Pat. No. 11,371,690 and U.S. Pat. No. 12,104,777, the disclosures of which are fully incorporated into this document by reference.

Each light fixture 10 includes a stand 12 such as a pole, tower, stand, yoke mount, or other structure that holds, supports, and positions above ground one or more luminaires 20. Each luminaire includes one or more light emitting devices such as light emitting diodes (LEDs) or lamps (including but not limited to those with incandescent, fluorescent, halogen, or halide lamps) that emit light toward the target area 14. The luminaires 20 may be arranged to extend laterally from the stand 12 as shown in FIG. 1, or they may be arranged in a different configuration.

The luminaires 20 are powered and controlled via a wiring harness 22 that extends along the interior or exterior of the stand 12 to a controller stack 24. The controller stack 24 is physically and/or electronically connected to or positioned near the stand 12 and includes one or more weather-resistant enclosures 26, which collectively contain a power supply, control circuitry for controlling the one or more luminaires, and memory, any or all of which may be combined into a common enclosure 26 and/or distributed among two or more of the enclosures 26. In some embodiments, the power supply of one or more of the controller stacks 24 may include one or more battery devices. Optionally, the power supply may include a solar panel that transforms solar energy into DC for operating the luminaires 20 and/or charging the battery. One or more of the enclosures 26 of the controller stack 24 also may include one or more drivers such as LED drivers for operating the luminaires 20. In embodiments where the power input is alternating current (AC), the LED drivers also may be configured to transform local electricity from AC to direct current (DC). Additional elements of an example controller stack 24 are disclosed in FIGS. 15-19 and the corresponding description of U.S. Pat. No. 11,371,690, the disclosure of which is fully incorporated into this document by reference.

As will be described in more detail below, one or more sensors may be attached to at least some of the light fixtures 10 and positioned to capture information about the target area 14. The sensors may be attached to the light stand 12, to any of the luminaires 14, and/or to the controller stack 24. The sensors may include a camera and a LiDAR system.

The system may also include a gateway controller 31, which in various embodiments may be positioned at the facility that includes the target area 14. The gateway controller 31 is a stationary or mobile electronic device that can be communicatively connected to each of the light fixtures 10 at the target area via wired or wireless communication, such as a wired or wireless local area network or any other suitable communication protocol. The gateway controller 31 includes a processor and a memory, with programming that enables the gateway controller 31 to send commands to control the light fixtures 10 and communicate with other electronic devices of the system. In some embodiments, to provide additional security the controller stacks 24 of the light fixtures and/or the sensors may communicate with each other and/or the gateway controller 31 via a private local area network that requires each device to present a valid authorization credential before it may access and use the network.

The system also may include a remote server 35. When used, remote server 35 may be positioned at the facility that includes the target area 14 or away from the facility at another location and configured to communicate with the facility via one or more communication networks 33 in a cloud-based arrangement. The remote server 35 may be configured to communicate directly with the light fixtures 10, e.g., by sending commands directly to and receiving information directly from a light fixture 10 over a wired or wireless communication protocol with no intervening devices. Alternatively, the remote server 35 may indirectly communicate with the light fixtures 10 by sending commands to and receiving information from the light fixture 10 via the gateway controller 31, which can relay communications to and from the light fixtures 10.

In some embodiments, the remote server and/or the gateway controller may include a user interface that enables an administrator to view data captured and processed by the system, to enter information such as information capture protocols or photometric plan data, to receive alerts, or to take other actions. Thus, in some embodiments the gateway controller 31 and/or the remote server 35 may operate as an administrator electronic device. Additionally or alternatively, the gateway controller 31 and/or the remote server 35 may communicate with a separate administrator electronic device via a wired or wireless communication protocol.

Any or all of the data processing steps described in this document may be performed by the gateway controller 31 and/or processing components of one or more of the individual controller stacks 24 in an edge computing arrangement, by the remote server 35, or by any combination of these. In some embodiments, one of the controller stacks 24 may perform at least some of the data processing functions as a master control node for the facility's data processing functions.

In addition, as noted above in some embodiments the camera and LiDAR sensors may be mounted in one or more of the light fixtures. In addition or alternatively, in some embodiments, the camera and/or the LiDAR sensors may be incorporated into other devices at the facility, such as in the gateway controller 31, in a mobile computing device, or in a separate data collection electronic device. In some embodiments, the gateway controller 31 itself may be incorporated in a mobile computing device or data collection electronic device.

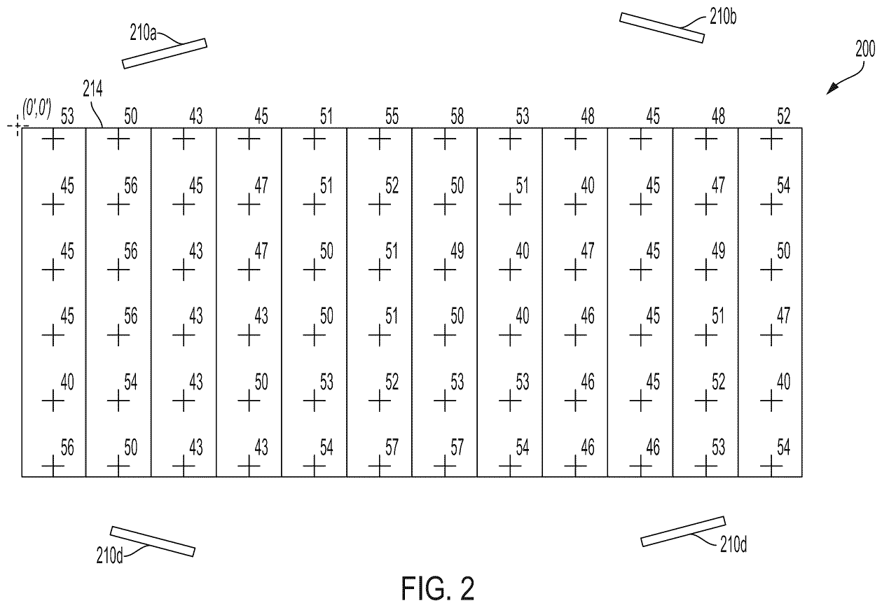

FIG. 2 illustrates example elements of a photometric plan 200 for a target area 214, which in this case is a football field. Multiple light fixtures 210a-210d (collectively referred to as 210) are positioned at various locations and directed toward the target area 214. The photometric plan 200 includes a detailed map of the lighting system's layout and light distribution metrics for the target area. For example, the photometric plan 200 identifies light characteristics that the light fixtures 210 cause to appear in the various regions of the target area 214. In this example, the light characteristic is illuminance, measured in foot-candles. Other units of measure, such as lux or vertical illuminance, could be used in other embodiments. The photometric plan may include specifications for additional or alternative light characteristics, such as vertical luminance or candela. Notably, the light characteristics are not necessarily equal in all locations of the target area 214. However, the values are all within a range or tolerance specified by the photometric plan 200.

The photometric plan 200 may also specify metrics for the position of each light fixture 210a. . . 210d, as well as metrics for the orientation of each light fixture's luminaires with respect to a target area of the facility or another point of reference. The photometric plan may specify these values in terms of ranges, or in terms of a value with an acceptable tolerance around the value, or in some other format.

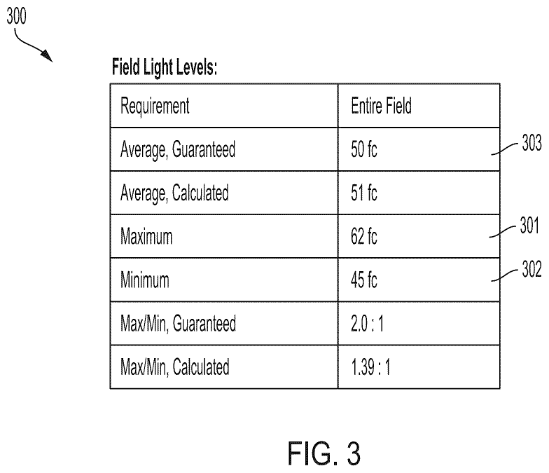

FIG. 3 illustrates an example illumination metrics 300 of a photometric plan that a system may reference and use to achieve the light characteristics shown in the illumination map of FIG. 2. In the example shown in FIG. 3, the illumination metrics 300 include a maximum light intensity 301, minimum light intensity 302, and average light intensity 303 over all areas of the field. The illumination metrics 300 also may provide for additional measurable light parameters, such as a ratio of maximum light level to minimum light level.

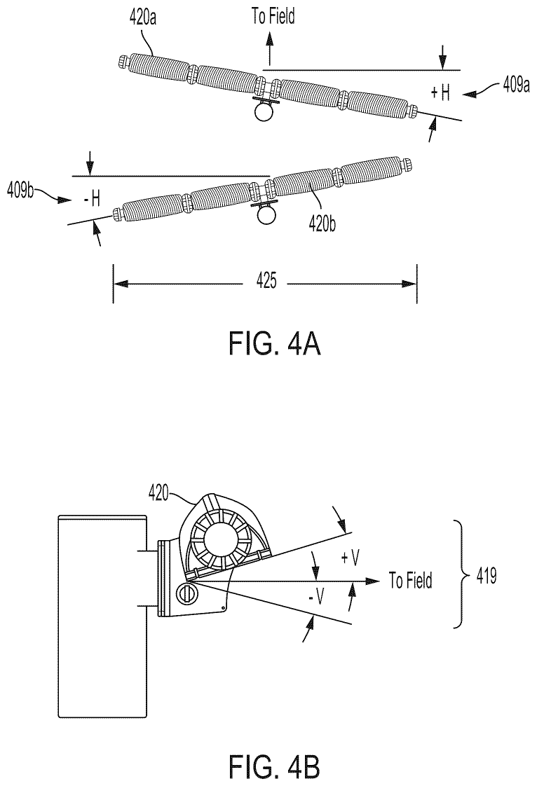

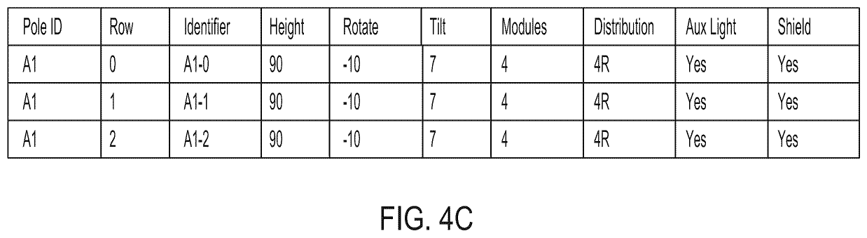

To implement a photometric plan such as that described above, the light fixtures should be positioned and oriented in accordance with the specifications of the photometric plan during installation and commissioning. The position and orientation of the light fixtures will be specified during system design. For example, referring to FIG. 4A, an example photometric plan specifies angles 409a, 409b at which the luminaires 420a, 420b should be oriented with respect to a horizontal boundary of the target area, such as an out-of-bounds line of a field or court, or a sideline or baseline of a field. Referring to FIG. 4B, the example photometric plan also specifies angles 419 at which the luminaires 420 should be oriented with respect to the ground level of the target area, such as ground level in a central region of the playing surface. FIG. 4C illustrates example height, position, and orientation metrics for a group of luminaires (designated as rows 0, 1, and 2) that are attached to a particular pole (pole ID A1). These metrics may be predetermined as part of the system design. Alternatively, the angles may be calculated and/or modified during installation as adjustments to luminaire positions are made in response to light level measurements at various locations in the target area. The specified angles may be specific numbers with allowable tolerances, or they may be ranges, to allow for some small variations in positioning of the luminaires. Optionally, the photometric plan also may specify an orientation of the luminaire with respect to an axis of the support pole or other stand on which the luminaire is mounted.

Once a photometric plan is created, the system may use components installed on the stands and/or controller stacks of the light fixtures, and/or sensors that are otherwise available at the facility, to determine whether the luminaires are positioned and oriented at the proper angles with respect to the target area. In some embodiments, the system may do this with cameras and LiDAR sensors that are attached to at least some of the light fixtures. In such embodiments, the cameras and LiDAR sensors may be installed at any suitable location, such as near the base (i.e., within a threshold distance from the bottom, such as the bottom ⅓ of fixture), near the top (i.e., within a threshold distance from the top, such as the top ⅓ of the fixture), or at other areas of the lighting stands, or integrated in the fixture's luminaires or controller stack, to capture data about the other light fixtures installed at the facility. Cameras and LiDAR sensors mounted at or near the top of the fixture may monitor parameters such as, among other things, lighting system functionality, field conditions, and 3D spatial mapping. Cameras and LiDAR sensors mounted at or near the base of the fixture may monitor, among other things, parameters such as ground-level activity, motion-triggered recording, and boundary monitoring. As noted above, in some embodiments cameras and LiDAR sensors may be integrated into other electronic devices at the facility, such as the gateway controller, a mobile electronic device, or a stand-alone data collection electronic device.

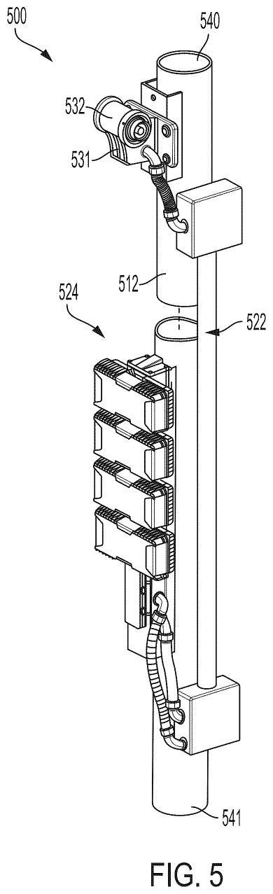

FIG. 5 illustrates an example light fixture 500 with a camera 531 and LiDAR sensor 532 mounted on the device's stand 512. (In FIG. 5, stand 512 is shown in broken form with a gap so that elements positioned at both near top 540 and near the base 541 (i.e., bottom) of the stand 512 can fit into the image.) The camera 531 and LiDAR sensor 532 may be positioned near the top 540 of the light fixture 500 as shown, or at other locations on the light fixture. The camera 531 and LiDAR sensor 532 may be directed toward the target area to capture images and LiDAR data of other light fixtures that are positioned around the target area. The camera 531 and LiDAR sensor 532 can transfer this data to the controller stack 524 via the wiring harness 522. The controller stack 524 includes hardware such as one or more processors, memory devices, and transceivers for storing and processing the data and transferring it to external elements of the system, such as the gateway controller or a remote server.

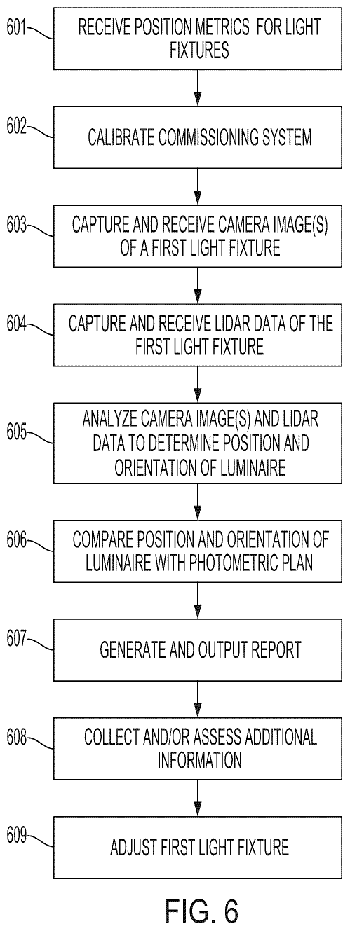

FIG. 6 illustrates an example process for commissioning a group of light fixtures at a facility using data captured from cameras and LiDAR sensors such as those described above. Any steps of the process of FIG. 6 may be implemented by a processor that may be installed in one of the light fixture's controller stacks, by the gateway controller, by another electronic device available at the facility such as a mobile electronic device carried by a person or a stand-alone data collection electronic device, or by a remote server. In some embodiments the processor may be part of a mobile electronic device that has an installed application that causes the mobile electronic device's processor to implement any or all of the steps described in FIG. 6. The steps may all be performed by a single processor, or the steps may be distributed among multiple processors. When the discussion below and the claims use the term “processor”, it is intended to include all such options unless the context specifically indicates otherwise.

At 601 the processor will receive position metrics for each light fixture that is included in the photometric plan. The processor may receive this by, for example, retrieving the photometric plan from a local memory or a remote data store (such as one in gateway controller 31 or remote server 35 of FIG. 1), by receiving the photometric plan from user input or via a messaging application, by another method. In some embodiments, the processor may receive the photometric plan in an image format, and if so the processor will process the image to extract the position metrics and other plan information from the image using methods such as optical character recognition, semantic search, and/or providing the image to a trained machine learning model to extract the relevant data and return the data to the processor.

The position metrics for each light fixture in the photometric plan may include, for example: (i) location of the light fixture, such as global positioning system (GPS) coordinates, a location with reference to a landmark, or a location with respect to a location in the target area; (ii) vertical orientation of one more of the device's luminaires with respect to ground of the target area; (iii) horizontal orientation of one or more of the device's luminaires with respect to a boundary of the target area; and (iv) orientation of one or more of the fixture's luminaires with respect to the vertical axis of the fixture's support pole or other stand. Examples of such metrics are discussed above in the context of FIGS. 4A-4C.

At 602, the processor may calibrate the commissioning system by receiving information indicating locations of the cameras or LiDAR sensors. For example, the system may receive information indicating the height of each camera and LiDAR sensor above ground, and/or the position of each camera and LiDAR sensor on the field. The information also may include identification of the other light fixtures that are in the field of view or perception of the camera or LiDAR sensor, as well as the horizontal distance of those fixtures to the camera or LiDAR sensor. The system may save the calibration data to a memory to use when determining position and orientation of the luminaires. Optionally, the system may use data captured during calibration to update a photometric plan to reflect as-built conditions at the facility.

At 603, the processor will cause a camera of at least one of the light fixtures in the group of light fixtures at the facility to capture a digital image. The images captured by at least some of the cameras will include a digital image that includes at least a first luminaire of a first light fixture. Thus, each camera that captures an image of the first light fixture will be one that is connected to a different light fixture of the group (i.e., a light fixture that is not the first light fixture).

At 604, the processor will cause a LiDAR sensor of at least one of the light fixtures of the group of light fixtures at the facility to capture LiDAR data. The LiDAR data will include a LiDAR image of at least the first luminaire of the first light fixture. Thus, each LiDAR sensor that captures a LiDAR image of the first luminaire also will be one that is connected to a different light fixture of the group (i.e., a light fixture that is not the first light fixture).

At 605, the processor will receive the digital camera images and LiDAR data via one or more wired and/or wireless communication paths, and the processor will process the images and LiDAR data to determine the position and orientation of the luminaire. The system may do this using any suitable image processing algorithms, using methods such as the calculation of image moments to find the object's equivalent ellipse and its axes. In such methods the central moments of the image (i.e., moments that centroid of the object) may be used to compute a covariance matrix, from which eigenvectors can be calculated. The angle of the eigenvector having the largest value may be selected as the angle corresponding to the object's major axis, which can then define the orientation of the object.

Other techniques that the system may use at 605 may include finding the object's major axis via principal component analysis (PCA), in which the data from multiple cameras and/or LiDAR is projected onto a common plane and the object's orientation is determined by techniques such as those described in Brereton, “Graphical introduction to principal components analysis,” Journal of Chemometrics 2022;36:e3404 (2022).

In some embodiments step 605 may include sending the image to a trained machine learning model, which can process the images and data and predict orientation of the luminaire in the images and data.

Step 605 also may include identifying the position or orientation of a luminaire using any suitable measure such as pitch, yaw, and/or roll. Yaw generally references the orientation of a device about a nadir axis. Pitch generally refers to the orientation of a device about a first axis perpendicular to the nadir axis, and roll references the orientation of a device about a third axis perpendicular to the nadir axis and the second axis.

In some embodiments, referring to FIG. 4A, the system may determine orientation of the luminaire by measuring the end-to-end width 425 of the luminaire in the image.

In some embodiments, the system may capture images and LiDAR data about the luminaire from multiple cameras and multiple LiDAR sensors that are positioned on different light fixtures at the facility. The system may use each of these images and point clouds individually, and/or it may compare, combine, or otherwise the multiple images and LiDAR data to refine and/or more accurately determine the position and orientation of the first luminaire. For example, the processor may generate a composite set of LiDAR data from the multiple LiDAR devices'data, such as by transforming the point cloud data from two or more of the LiDAR devices into a common coordinate system, and merging them into a single, combined point cloud. Other now known or hereafter known methods of fusing point cloud data from multiple sensors may be used. The system may then render this combined point cloud into a 2D image format, such as by projecting the data onto a 2D plane using techniques like spherical projection to create an equirectangular image. The system also may generate a composite digital image from all of the multiple cameras' images, such as by selecting a base image and layering the other images over the base image, or by using third party tools such as the “photomerge” feature in the Photoshop image editing tool from Adobe Inc.

Optionally, whether the system uses individual LiDAR data sets and images or generates composites, the system may discard LiDAR data or images that are of insufficient quality, or which contain results that substantially deviate from a mean result.

At 606, the processor will compare the determined position and orientation to the position metrics to assess whether the luminaire is positioned and oriented in accordance with the photometric plan. The system may do this by calculating a difference between the determined position and orientation and those of the photometric plan. For example, the photometric plan may specify a geometric pattern for the light fixture, and the system may determine whether a captured image fits that pattern. The system may do this by measuring angles in the image and assessing whether they match angles in the photometric plan's pattern, by creating a mask for the pattern and assessing whether the light fixture in the image fits the pattern, or by some other method, The system may do this on a camera-by-camera basis, using a unique pattern corresponding to each camera's field of view, or it may do this on a composite image basis with a composite pattern.

In some embodiments, the system may use additional algorithms, and/or a trained machine learning model, to process the data to determine whether it is consistent with the photometric plan at 606. For example, the system may send captured images to a model that has been trained to recognize the pattern and classify the captured images as either fitting the pattern or deviating from the pattern.

In embodiments where the system measures the end-to-end width of the luminaire at 606, the measuring may include comparing the measured width to an expected width of the luminaire in the camera or LiDAR sensor's field of view. If the measured width is larger or smaller than the expected width, the system may determine that the light is not oriented around the stand at a specified angle with respect to a reference line such as a field boundary. End-to-end width measurements in camera images and LiDAR data may reveal minor deviations from specifications that are not perceptible to the human eye, such as deviations in orientation by angles of 2 degrees, one degree, or a fraction of a degree, but which can nonetheless cause light characteristics on the field to deviate from a photometric plan.

In any of the assessment options of step 606, the system may factor the calibration data collected at 602 in the calculation of a luminaire's position and orientation. This factor and the particular algorithms used may vary based on the field dimensions, placement of light fixtures, and placement of cameras and LiDAR sensors at a particular facility.

At 607, the processor will output a report indicating whether the luminaire is positioned and oriented in accordance with the photometric plan, optionally along with the adjustments that are required to re-orient the fixture to match the photometric plan. For example, referring to FIG. 4C, if processor determines that the pole labeled as Pole A1 is not positioned within a specified tolerance of 90 degrees with respect to the ground, and that the luminaire that is attached to Pole A1 at the location on the pole labeled as Row 2 is not within a specified tolerance of −10 degrees horizontal rotation or 7 degrees vertical tilt, the system may notify an operator that the luminaire's position and orientation must be adjusted to satisfy the photometric plan. In some embodiments, the notification also may include the amount of deviation and/or instructions for re-orienting the luminaire to align it with the specifications of the photometric plan. In other embodiments, a technician may review the report and manually determine the required adjustments by comparing the measured information in the report to the specifications of the photometric plan.

The processor may provide the notification at 607 via an electronic message, an audible alert, a visual alert displayed on a display screen, or some other notification method to any of the electronic devices described above, or to a remote technician via a messaging application. In some embodiments, the processor may cause the problematic light fixture itself to present the notification, such as by causing the light fixture's luminaires to operate according to an alert protocol such as a flashing sequence, or a pattern of cycling between relatively dim and relatively bright states.

At 609, if the processor determines that a luminaire is not oriented in accordance with the specifications, a technician or mechanical device (such as motor) may adjust the position and/or orientation of the luminaire to make it consistent with the specifications of photometric plan.

In some embodiments, the process described above in FIG. 6 may be initiated by the remote server so that the local system can capture camera and LiDAR data and return it to the server. This allows a technician to remotely diagnose whether a luminaire is properly oriented before visiting the facility or climbing the light fixture to measure and adjust the device. This can save significant time and effort associated with installation and maintenance of the lighting system.

In some embodiments, the integration of cameras and LiDAR sensors in the light fixtures themselves may help to provide for continuous and/or periodic monitoring of the fixtures' positions and orientations. The data capture can be triggered by a command from a remote server, or by programming instructions installed locally in the controller stack of a facility's light fixtures or in the facility's gateway controllers. The use of cameras also can allow the system to capture live images and/or LiDAR data return the images and data to the remote server for real-time review by remote personnel.

Alternatively or in addition, the monitoring process may be an automatic process, with captured data compared to baseline data from the photometric plan to automatically determine when any fixture's position and orientation deviates from its baseline position and orientation by more than a threshold amount. In some embodiments, the system may perform data capture and processing at a specified time before an event that will take place at the facility, so that the pre-event scans check the operational status of light fixtures including fixture alignment as described above.

Optionally, at 608 the scans can also check other information, such intensity and color temperature of light emitted each fixture during operation. For example, in addition to measuring a luminaires' position and orientation, the system may selectively cause a single light fixture, or even a single luminaire of a light fixture, to turn on. When this happens, the system may cause one or more cameras that face the light fixture to capture an image of the fixture while it is on. The system may then measure the intensity and color temperature of the emitted light by any suitable image processing method, such as by measuring the intensity and hue of pixels in the camera image or a composite image. The system may compare the measured data with baseline data from previous scans and/or the photometric plan to determine whether the measured data is consistent with the baseline data. This can provide additional diagnostic functions, which a technician also may use to adjust the light fixture at 609 such as by replacing LEDs and/or adjusting control circuitry. For example, referring to FIG. 4B, if an image does not show light of an expected intensity in substantially all of an expected region of image (such as fewer than an expected number of pixels), it may conclude that the luminaire 420 has been rotated downward and is directing less than a specified amount of light toward the field. If the image shows light above (i.e., exceeding) the threshold intensity outside of the expected region of the image, it may conclude that the luminaire 420 has been rotated upward and is directing more than the specified amount of light toward the field.

In some embodiments, one or more of the light fixtures may incorporate a motion sensor, and the system may initiate camera and/or LiDAR data collection upon detection of motion at a time that is outside of a scheduled event time. When enabled, this feature can provide the additional benefit of security, as it can capture images and LiDAR data showing when an unauthorized person has entered the facility, and/or when a person has entered the facility at an unauthorized time.

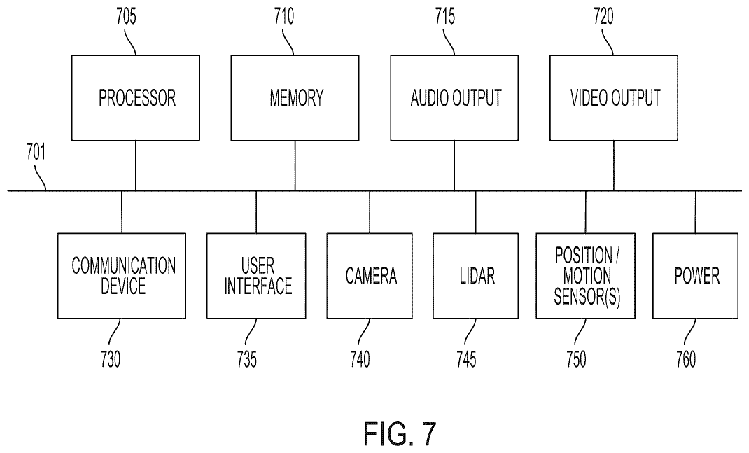

FIG. 7 depicts an example of internal hardware that may be included in any of the electronic devices of the system, such as gateway controller, an administrator electronic device, the remote server, and/or controller stack. A bus such as that of one or more circuit boards 701 serves as a communication path via which messages, instructions, data, or other information may be shared among the other illustrated components of the hardware. Processor 705 is a central processing device of the system, configured to perform calculations and logic operations required to execute programming instructions. A memory 710 is a non-transitory device or collection of devices across which data and/or instructions are stored.

The electronic device may display information processed by the processor 705 on a video output device 720 (i.e., a display device) in visual, graphic, and/or alphanumeric format. Example video output devices include display screens, heads-up displays such as those used in virtual reality and augmented reality devices, projection devices, and video output ports such as HDMI ports that transfer information to an external display device. An audio output device 715 such as a speaker, video output port, or wireless transceiver such as those that operate via a Bluetooth® or other wireless communication protocol.

Communication with external displays, audio outputs, and electronic devices also may occur using various communication circuit devices 730 such as a wireless antenna, a radio frequency identification (RFID) tag and/or short-range or near-field communication transceiver, each of which may optionally communicatively connect with other components of the electronic device. The communication circuit devices 730 may be configured to be communicatively connected to a communications network, such as the Internet, a local area network or a cellular telephone data network. In some embodiments, the communication devices may be configured to support dual-frequency operation that will use (a) a relatively low frequency (such as 915 MHz) for low-latency device-to-device communications (as in an Internet of Things arrangement) for real-time diagnostics, commissioning, and alerts, and (b) a relatively high frequency (such as 2.4 GHz or 5 GHz) to provides high-speed data transmission for live video streaming, LiDAR-based 3D maps, and communications with the remote server.

The electronic device also may also include a user interface device 735 that includes one or more input devices that can receive data and/or commands from a user. Example user interface devices 735 include a keyboard, a mouse, touchscreen that is part of a display device of the video output 720, a touch pad, a remote control, a pointing device, and/or a microphone.

A camera 740 will include image sensors and other hardware that can capture video and/or still images. Some embodiments also may include a LiDAR sensor 745 as described above.

The electronic device also may include one or more positional and/or motion sensors 750 that can detect position and movement of the device and/or of objects external to the device. Examples of motion sensors that can detect position and movement of the device include gyroscopes, accelerometers, and inertial measurement units (IMUs). Examples of motion sensors that detect external motion include those that use passive infrared technology to monitor ambient temperature of a space and detect sudden changes in the temperature, or active sensors that emit and receive microwaves or sound waves and detect changes in reflection time of the waves. Examples of positional sensors include a global positioning system (GPS) sensor device that receives positional data from an external GPS network.

The electronic device also will include a power module 760 that, in operation, will provide power to the other components of the electronic device. The power module 760 may include an internal battery, a power port that will receive power when electrically connected to an external power source, a power management integrated circuit (PMIC), a DC-to-DC converter or AC-to-DC converter, a receiving coil for inductive charging, other power circuit components, and/or a combination of any of these.

Based on the teachings contained in this disclosure, it will be apparent to persons skilled in the relevant art(s) how to make and use embodiments of this disclosure using data processing devices, computer systems and/or computer architectures other than that shown in FIG. 7.

In addition to the patents incorporated by reference above, this patent document also incorporates the disclosures of the following patents by reference in their entirety: U.S. Pat. No. 11,644,193; U.S. Pat. No. 11,209,153; and U.S. Pat. No. 11,284,492; and U.S. Pat. No. 11,371,690.

The following paragraphs provide additional information about various terms used in this document:
In this document, when terms such as “first” and “second” are used to modify a noun, such use is simply intended to distinguish one item from another and is not intended to require a sequential order unless specifically stated.

The term “approximately” when used in connection with a numeric value, is intended to include values that are close to, but not exactly, the number. For example, in some embodiments, the term “approximately” may include values that are within +/−10 percent (or, in some embodiments, +/−5 percent, +/−3 percent, or +/−1 percent) of the value.

The term “substantially,” when used in connection with a value, is intended to mean approximately, within a threshold tolerance that is a percentage corresponding to any of the percentages described in the previous paragraph. For example, items described as “substantially the same,” “substantially equal,” or “substantially planar,” may be exactly the same, equal, or planar, or may be the same, equal, or planar within acceptable variations that may occur, for example, due to manufacturing processes and/or tolerances.

In this document, the term “connected,” when referring to two physical structures, means that the two physical structures touch each other. Devices that are connected may be secured to each other, or they may simply touch each other and not be secured.

In this document, the term “electrically connected,” when referring to two electrical components, means that a conductive path exists between the two components. The path may be a direct path, or an indirect path through one or more intermediary components.

An “electronic device” or a “computing device” refers to a device or system that includes a processor and memory. Each device may have its own processor and/or memory, or the processor and/or memory may be shared with other devices as in a virtual machine or container arrangement. The memory will contain or receive programming instructions that, when executed by the processor, will cause the electronic device to perform one or more operations according to the programming instructions. Examples of electronic devices include personal computers, servers, mainframes, virtual machines, containers, gaming systems, televisions, digital home assistants and mobile electronic devices such as smartphones, fitness tracking devices, wearable virtual or augmented reality devices, Internet-connected wearables such as smart watches and smart eyewear, personal digital assistants, cameras, tablet computers, laptop computers, media players and the like. Electronic devices also may include components of vehicles such as dashboard entertainment and navigation systems, as well as on-board vehicle diagnostic and operation systems. In a client-server arrangement, the client device and the server are electronic devices, in which the server contains instructions and/or data that the client device accesses via one or more communications links in one or more communications networks. In a virtual machine arrangement, a server may be an electronic device, and each virtual machine or container also may be considered an electronic device. In the discussion above, a client device, server device, virtual machine or container may be referred to simply as a “device” for brevity. Additional elements that may be included in electronic devices are discussed above in the context of FIG. 6.

The terms “processor,” “processing device,” and “controller” refer to electronic device hardware that is configured to execute programming instructions. These terms may refer to a single processing device or any number of processing devices in a set of processors that collectively perform a set of operations. Thus, unless the context specifically states that a single processor or controller is required or that multiple processors or controllers are required, the terms “processor” and “controller” include both the singular and plural embodiments. Example processing devices include, a central processing unit (CPU), a graphics processing unit (GPU), a remote server, or a combination of these.

The terms “memory,” “memory device,” “computer-readable medium,” and “data store” each refer to a non-transitory device on which computer-readable data, programming instructions or both are stored. Read only memory (ROM), random access memory (RAM), flash memory, hard drives and other devices capable of storing electronic data constitute examples of memory devices. A “computer program product” is a combination of a memory device and the programming instructions stored in it. Unless the context specifically states that a single device is required or that multiple devices are required, the terms defined in this paragraph include both the singular and plural embodiments, as well as portions of such devices such as memory sectors.

A “server” is a computing device that includes one or more processors and one or more memory devices.

In this document, the terms “communication link,” “communication path,” and “communication circuit” mean a wired or wireless path or paths and associated hardware via which a first device sends communication signals to and/or receives communication signals from one or more other devices. Devices are “communicatively connected” if the devices are able to send and/or receive data via a communication link. “Electronic communication” refers to the transmission of data via one or more signals between two or more electronic devices, whether through a wired or wireless network, and whether directly or indirectly via one or more intermediary devices. The network may include or is configured to include any now known or hereafter known communication networks such as, without limitation, a BLUETOOTH® communication network, a Z-Wave® communication network, a wireless fidelity (Wi-Fi) communication network, a ZigBee communication network, a HomePlug communication network, a Power-line Communication (PLC) communication network, a message queue telemetry transport (MQTT) communication network, a MTConnect communication network, a cellular network a constrained application protocol (CoAP) communication network, a representative state transfer application protocol interface (REST API) communication network, an extensible messaging and presence protocol (XMPP) communication network, a cellular communications network, any similar communication networks, or any combination thereof for sending and receiving data. As such, a network may be configured to implement wireless or wired communication through cellular networks, WiFi, BlueTooth, Zigbee, RFID, BlueTooth low energy, NFC, IEEE 802.11, IEEE 802.15, IEEE 802.16, Z-Wave, Home Plug, global system for mobile (GSM), general packet radio service (GPRS), enhanced data rates for GSM evolution (EDGE), code division multiple access (CDMA), universal mobile telecommunications system (UMTS), long-term evolution (LTE), LTE-advanced (LTE-A), MQTT, MTConnect, CoAP, REST API, XMPP, or another suitable wired and/or wireless communication method.

In this document, the term “camera,” when used in connection with a camera of a mobile electronic device generally refers to a hardware sensor that can acquire digital images. A camera may capture still and/or video images, and optionally may be used for other imagery-related applications. For example, a camera can be held by a user such as a DSLR (digital single lens reflex) camera, cell phone camera, or video camera. The camera may be part of an image capturing system that includes other hardware components.

A “machine learning model” or a “model” refers to a set of algorithmic routines and parameters that can predict an output(s) of a real-world process (e.g., prediction of an object trajectory, a diagnosis or treatment of a patient, a suitable recommendation based on a user search query, etc.) based on a set of input features, without being explicitly programmed. A structure of the software routines (e.g., number of subroutines and relation between them) and/or the values of the parameters can be determined in a training process, which can use actual results of the real-world process that is being modeled. Such systems or models are understood to be necessarily rooted in computer technology, and in fact, cannot be implemented or even exist in the absence of computing technology. While machine learning systems perform various types of statistical analyses, machine learning systems are distinguished from statistical analyses by virtue of the ability to learn without explicit programming and being rooted in computer technology.

“Training” of a machine learning model may include building and/or updating a machine learning model from a sample dataset (referred to as a “training set”), evaluating the model against one or more additional sample datasets (referred to as a “validation set” and/or a “test set”) to decide whether to keep the model and to benchmark how good the model is, and using the model in a production environment to make predictions or decisions, or to generate content, based on new input data.

The features and functions described above, as well as alternatives, may be combined into many other different systems or applications. Various alternatives, modifications, variations or improvements may be made by those skilled in the art, each of which is also intended to be encompassed by the disclosed embodiments.

As described above, this document discloses system, method, and computer program product embodiments. The system embodiments include a local computing device, which may have access to one or more remote computing devices. In some embodiments, one or more of the remote computing devices also may be part of the system. The computer program embodiments include programming instructions, stored in a memory device, that are configured to cause a processor to perform the methods described in this document.

Various embodiments include, without limitation, those represented by the following clauses:

Clause 1: A method of commissioning a lighting system, the method comprising, by a processor: (i) receiving a photometric plan for a group of light fixtures, wherein the photometric plan includes position metrics for each of the light fixtures at a facility, and the position metrics for each light fixture include a location of the light fixture and an orientation of a luminaire of the light fixture; (ii) receiving a digital image of a first luminaire of a first light fixture of the group, wherein the digital image is received from a camera that is connected to a second light fixture of the group; (iii) receiving LiDAR data that represents a LiDAR image of the first luminaire, wherein the LiDAR data is received from a LiDAR sensor that is connected to the second light fixture or another light fixture of the group; (iv) processing the digital image and the LiDAR data to determine an orientation of the first luminaire; (v) comparing the determined orientation to the position metrics to assess whether the first luminaire is oriented in accordance with the photometric plan; and (vi) outputting a report indicating whether the first luminaire is oriented in accordance with the photometric plan.

Clause 2: The method of clause 1, further comprising adjusting an orientation of the first luminaire in response to the report.

Clause 3: The method of clause 1 or 2, further comprising, by the processor, causing the camera to capture the digital image, and causing the LiDAR sensor to capture the LiDAR data.

Clause 4: The method of clause 3, wherein the processor is in a location at the facility in an edge computing arrangement, and the processor is in communication with the camera and the LiDAR sensor.

Clause 5: The method of any of clauses 1-4, further comprising receiving additional digital images of the first luminaire, wherein the additional digital images are received from additional cameras that are connected to additional light fixtures of the group, and wherein processing the digital camera image and LiDAR data to determine the position and the orientation of the luminaire also comprises processing the additional digital images.

Clause 6: The method of clause 5, wherein processing the additional digital images comprises: (i) generating a composite image from two or more of the digital images; and (ii) using the composite image to determine the position and the orientation of the luminaire.

Clause 7: The method of any of clauses 1-6, further comprising receiving additional LiDAR data for the first luminaire, wherein the additional LiDAR data is received from additional LiDAR sensors that are connected to additional light fixtures of the group, and wherein processing the digital camera image and LiDAR data to determine a position and an orientation of the luminaire also comprises processing the additional LiDAR data.

Clause 8: The method of clause 7, wherein processing the additional LiDAR data comprises: (i) transforming point cloud data from two or more of the LiDAR sensors into a common coordinate system, and merging the transformed point cloud data into a single, combined point cloud; and (ii) using the combined point cloud to determine the position and the orientation of the luminaire.

Clause 9: The method of any of clauses 1-8, wherein: (i) processing the digital image and the LiDAR data to determine the orientation of the first luminaire comprises measuring an end-to-end width of the luminaire; and (ii) comparing the determined orientation to the position metrics to assess whether the first luminaire is oriented in accordance with the photometric plan comprises determining whether the measured end-to-end width corresponds to an expected end-to-end width.

Clause 10: The method of any of clauses 1-9, wherein: (i) processing the digital image and the LiDAR data to determine the orientation of the first luminaire comprises measuring intensity of light in a region of the digital image; and (ii) comparing the determined orientation to the position metrics to assess whether the first luminaire is oriented in accordance with the photometric plan comprises determining whether (a) the measured intensity of light does not exceed a threshold intensity in substantially all of the region, or (b) the measured intensity of light exceeds the threshold intensity outside of the region.

Clause 11: A light commissioning system, comprising: (i) a processor; (ii) a memory storing a photometric plan for a group of light fixtures, wherein (a) the photometric plan includes position metrics for each of the light fixtures at a facility, and (b) the position metrics for each light fixture include a location of the light fixture and an orientation of a luminaire of the light fixture; and (iii) a memory containing programming instructions. The programming instructions will, when executed, cause the processor to: (a) receive a digital image of a first luminaire of a first light fixture of the group, wherein the digital image is received from a camera that is connected to a second light fixture of the group; (b) receive LiDAR data that represents a LiDAR image of the first luminaire, wherein the LiDAR data is received from a LiDAR sensor that is connected to the second light fixture or another light fixture of the group; (c) process the digital image and the LiDAR data to determine an orientation of the first luminaire; (d) compare the determined orientation to the position metrics to assess whether the first luminaire is oriented in accordance with the photometric plan; and (e) output a report indicating whether the first luminaire is oriented in accordance with the photometric plan.

Clause 12: The system of clause 11, further comprising additional programming instructions to: (i) cause the camera to capture the digital image; and (ii) cause the LiDAR sensor to capture the LiDAR data.

Clause 13: The system of clause 11 or 12, wherein the processor is: (i) in a location at the facility in an edge computing arrangement; and (ii) in communication with the camera and the LiDAR sensor.

Clause 14: The system of any of clauses 11-13, further comprising additional programming instructions to, in response to receiving additional digital images of the first luminaire from additional cameras that are connected to additional light fixtures of the group, and when processing the digital camera image and LiDAR data to determine the position and the orientation of the luminaire, also process the additional digital images.

Clause 15: The system of clause 14, wherein the instructions to process the additional digital images comprise instructions to: (i) generate a composite image from two or more of the digital images; and (ii) use the composite image to determine the position and the orientation of the luminaire.

Clause 16: The system of any of clauses 11-15, further comprising additional programming instructions to, in response to receiving additional LiDAR data for the first luminaire from additional LiDAR sensors that are connected to additional light fixtures of the group, and when processing the digital camera image and LiDAR data to determine a position and an orientation of the luminaire, also process the additional LiDAR data.

Clause 17: The system of clause 16, wherein the instructions to process the additional LiDAR data comprise instructions to: (i) transform point cloud data from two or more of the LiDAR sensors into a common coordinate system, and merging the transformed point cloud data into a single, combined point cloud; and (ii) use the combined point cloud to determine the position and the orientation of the luminaire.

Clause 18: The system of any of clauses 11-17, wherein: (i) the instructions to process the digital image and the LiDAR data to determine the orientation of the first luminaire comprise instructions to measure an end-to-end width of the luminaire; and (ii) the instructions to compare the determined orientation to the position metrics to assess whether the first luminaire is oriented in accordance with the photometric plan comprise instructions to determine whether the measured end-to-end width corresponds to an expected end-to-end width.

Clause 19: The system of any of clauses 11-18, wherein: (i) the instructions to process the digital image and the LiDAR data to determine the orientation of the first luminaire comprise instructions to measure intensity of light in a region of the digital image; and (ii) the instructions to compare the determined orientation to the position metrics to assess whether the first luminaire is oriented in accordance with the photometric plan comprise instructions to determine whether (a) the measured intensity of light does not exceed a threshold intensity in substantially all of the region, or (b) the measured intensity of light exceeds the threshold intensity outside of the region.

Clause 20: A light system, comprising a group of light fixtures positioned to direct light toward a target area of a facility, wherein each light fixture includes a stand and one or more luminaires. The system of this clause also comprises a plurality of cameras, each of which is connected to one of the light fixtures, and a plurality of LiDAR sensors, each of which is connected to one of the light fixtures. The system of this clause also includes a processor, and a memory storing a photometric plan for the group of light fixtures, wherein the photometric plan includes position metrics for each of the light fixtures, and wherein the position metrics for each light fixture include a location of the light fixture and an orientation of the one or more luminaires of the light fixture. The system of this clause also includes a memory containing programming instructions that upon execution will, when executed, cause the processor to: (i) receive a digital image of a first luminaire of a first light fixture of the group, wherein the digital image is received from a camera that is connected to a second light fixture of the group; (ii) receive LiDAR data that represents a LiDAR image of the first luminaire, wherein the LiDAR data is received from a LiDAR sensor that is connected to the second light fixture or another light fixture of the group; (iii) process the digital image and the LiDAR data to determine an orientation of the first luminaire; (iv) compare the determined orientation to the position metrics to assess whether the first luminaire is oriented in accordance with the photometric plan; and (v) output a report indicating whether the first luminaire is oriented in accordance with the photometric plan.

Clause 21: The system of clause 20, further comprising any of the elements of any of clauses 12-19.

1. A method of commissioning a lighting system, the method comprising, by a processor:
receiving a photometric plan for a group of light fixtures, wherein:
the photometric plan includes position metrics for each of the light fixtures at a facility, and
the position metrics for each light fixture include a location of the light fixture and an orientation of a luminaire of the light fixture;
receiving a digital image of a first luminaire of a first light fixture of the group, wherein the digital image is received from a camera that is connected to a second light fixture of the group;
receiving LiDAR data that represents a LiDAR image of the first luminaire, wherein the LiDAR data is received from a LiDAR sensor that is connected to the second light fixture or another light fixture of the group;
processing the digital image and the LiDAR data to determine an orientation of the first luminaire;
comparing the determined orientation to the position metrics to assess whether the first luminaire is oriented in accordance with the photometric plan; and
outputting a report indicating whether the first luminaire is oriented in accordance with the photometric plan.

2. The method of claim 1, further comprising adjusting an orientation of the first luminaire in response to the report.

3. The method of claim 1, further comprising, by the processor:
causing the camera to capture the digital image; and
causing the LiDAR sensor to capture the LiDAR data.

4. The method of claim 3, wherein the processor is in a location at the facility in an edge computing arrangement, and the processor is in communication with the camera and the LiDAR sensor.

5. The method of claim 1, further comprising:
receiving additional digital images of the first luminaire, wherein the additional digital images are received from additional cameras that are connected to additional light fixtures of the group;
wherein processing the digital camera image and LiDAR data to determine the position and the orientation of the luminaire also comprises processing the additional digital images.

6. The method of claim 5, wherein processing the additional digital images comprises:
generating a composite image from two or more of the digital images; and
using the composite image to determine the position and the orientation of the luminaire.

7. The method of claim 1, further comprising:
receiving additional LiDAR data for the first luminaire, wherein the additional LiDAR data is received from additional LiDAR sensors that are connected to additional light fixtures of the group;
wherein processing the digital camera image and LiDAR data to determine a position and an orientation of the luminaire also comprises processing the additional LiDAR data.

8. The method of claim 7, wherein processing the additional LiDAR data comprises:
transforming point cloud data from a two or more of the LiDAR sensors into a common coordinate system, and merging the transformed point cloud data into a single, combined point cloud; and
using the combined point cloud to determine the position and the orientation of the luminaire.

9. The method of claim 1, wherein:
processing the digital image and the LiDAR data to determine the orientation of the first luminaire comprises measuring an end-to-end width of the luminaire; and
comparing the determined orientation to the position metrics to assess whether the first luminaire is oriented in accordance with the photometric plan comprises determining whether the measured end-to-end width corresponds to an expected end-to-end width.

10. The method of claim 1, wherein:
processing the digital image and the LiDAR data to determine the orientation of the first luminaire comprises measuring intensity of light in a region of the digital image; and
comparing the determined orientation to the position metrics to assess whether the first luminaire is oriented in accordance with the photometric plan comprises determining whether:
the measured intensity of light does not exceed a threshold intensity in substantially all of the region, or
the measured intensity of light exceeds the threshold intensity outside of the region.

11. A light commissioning system, comprising:
a processor,
a memory storing a photometric plan for a group of light fixtures, wherein:
the photometric plan includes position metrics for each of the light fixtures at a facility, and
the position metrics for each light fixture include a location of the light fixture and an orientation of a luminaire of the light fixture; and
a memory containing programming instructions that upon execution will, when executed, cause the processor to:
receive a digital image of a first luminaire of a first light fixture of the group, wherein the digital image is received from a camera that is connected to a second light fixture of the group,
receive LiDAR data that represents a LiDAR image of the first luminaire, wherein the LiDAR data is received from a LiDAR sensor that is connected to the second light fixture or another light fixture of the group,
process the digital image and the LiDAR data to determine an orientation of the first luminaire,
compare the determined orientation to the position metrics to assess whether the first luminaire is oriented in accordance with the photometric plan, and
output a report indicating whether the first luminaire is oriented in accordance with the photometric plan.

12. The system of claim 11, further comprising additional programming instructions to:
cause the camera to capture the digital image; and
cause the LiDAR sensor to capture the LiDAR data.

13. The system of claim 12, wherein the processor is:
in a location at the facility in an edge computing arrangement; and
in communication with the camera and the LiDAR sensor.

14. The system of claim 11, further comprising additional programming instructions to, in response to receiving additional digital images of the first luminaire from additional cameras that are connected to additional light fixtures of the group:
when processing the digital camera image and LiDAR data to determine the position and the orientation of the luminaire, also process the additional digital images.

15. The system of claim 14, wherein the instructions to process the additional digital images comprise instructions to:
generate a composite image from two or more of the digital images; and
use the composite image to determine the position and the orientation of the luminaire.

16. The system of claim 11, further comprising additional programming instructions to, in response to receiving additional LiDAR data for the first luminaire from additional LiDAR sensors that are connected to additional light fixtures of the group:
when processing the digital camera image and LiDAR data to determine a position and an orientation of the luminaire, also process the additional LiDAR data.

17. The system of claim 16, wherein the instructions to process the additional LiDAR data comprise instructions to:
transform point cloud data from a two or more of the LiDAR sensors into a common coordinate system, and merging the transformed point cloud data into a single, combined point cloud; and
use the combined point cloud to determine the position and the orientation of the luminaire.

18. The system of claim 11, wherein:
the instructions to process the digital image and the LiDAR data to determine the orientation of the first luminaire comprise instructions to measure an end-to-end width of the luminaire; and
the instructions to compare the determined orientation to the position metrics to assess whether the first luminaire is oriented in accordance with the photometric plan comprise instructions to determine whether the measured end-to-end width corresponds to an expected end-to-end width.

19. The system of claim 11, wherein:
the instructions to process the digital image and the LiDAR data to determine the orientation of the first luminaire comprise instructions to measure intensity of light in a region of the digital image; and
the instructions to compare the determined orientation to the position metrics to assess whether the first luminaire is oriented in accordance with the photometric plan comprise instructions to determine whether:
the measured intensity of light does not exceed a threshold intensity in substantially all of the region, or
the measured intensity of light exceeds the threshold intensity outside of the region.

20. A light system, comprising:
a group of light fixtures positioned to direct light toward a target area of a facility, wherein each light fixture includes a stand and one or more luminaires;
a plurality of cameras, each of which is connected to one of the light fixtures;
a plurality of LiDAR sensors, each of which is connected to one of the light fixtures;
a processor,
a memory storing a photometric plan for the group of light fixtures, wherein:
the photometric plan includes position metrics for each of the light fixtures, and
the position metrics for each light fixture include a location of the light fixture and an orientation of the one or more luminaires of the light fixture; and
a memory containing programming instructions that upon execution will, when executed, cause the processor to:
receive a digital image of a first luminaire of a first light fixture of the group, wherein the digital image is received from a camera that is connected to a second light fixture of the group,
receive LiDAR data that represents a LiDAR image of the first luminaire, wherein the LiDAR data is received from a LiDAR sensor that is connected to the second light fixture or another light fixture of the group,
process the digital image and the LiDAR data to determine an orientation of the first luminaire,
compare the determined orientation to the position metrics to assess whether the first luminaire is oriented in accordance with the photometric plan, and
output a report indicating whether the first luminaire is oriented in accordance with the photometric plan.
